(19) United States
(12) Patent Application Publication
(10) Pub. No.: US 2021/0097284 A1
(43) Pub. Date: Apr. 1, 2021

(54) TECHNIQUES FOR PRESENTATION OF ELECTRONIC CONTENT RELATED TO PRINTED MATERIAL

(71) Applicant: Lenovo (Singapore) Pte. Ltd., Singapore (SG)

(72) Inventor: Jonathan Co Lee, Cary, NC (US)

(21) Appl. No.: 16/588,364

(22) Filed: Sep. 30, 2019

(51) Int. Cl. G06K 9/00; G06F 3/01; G06K 9/20

(52) U.S. Cl. CPC G06K 9/00671; G06K 9/00469; G06K 2209/501; G06K 9/2054; G06F 3/012

(57) ABSTRACT

In one aspect, a headset may include at least one processor, at least one display accessible to the at least one processor, and storage accessible to the at least one processor. The storage may include instructions executable by the at least one processor to identify a non-electronic printed publication held by a user, where the non-electronic printed publication includes pages with text. The instructions may also be executable to access electronic content related to the non-electronic printed publication based on the identification and to present an indication regarding the electronic content on the at least one display.

### FIELD

The present application relates to technically inventive, non-routine solutions that are necessarily rooted in computer technology and that produce concrete technical improvements.

### BACKGROUND

As recognized herein, many books and other printed materials were created before the advent of modern technology. As also recognized herein, modern technology such as augmented reality (AR) systems may be employed to provide enhanced user interfaces for people. However, there are currently no adequate ways to use existing AR systems to provide electronic user interfaces for users to more robustly engage with printed materials since the printed materials are often not tailored for such AR systems and were often published before modern computing systems came to market. There are currently no adequate solutions to the foregoing computer-related, technological problem.

### SUMMARY

Accordingly, in one aspect a headset includes at least one processor, at least one display accessible to the at least one processor, and storage accessible to the at least one processor. The storage includes instructions executable by the at least one processor to identify a non-electronic printed publication held by a user, where the non-electronic printed publication includes pages with text. The instructions are also executable to access electronic content related to the non-electronic printed publication based on the identification and to present an indication regarding the electronic content on the at least one display.

The non-electronic printed publication may be a book, a magazine, or a newspaper.

Additionally, in some examples the headset may include a camera accessible to the at least one processor and the non-electronic printed publication may be identified based on input from the camera. Thus, in various examples the non-electronic printed publication may be identified based on input from the camera by one or more of: a title of the non-electronic printed publication, a cover or cover page of the non-electronic printed publication, author of the non-electronic printed publication, one or more images shown in the non-electronic printed publication, and/or universal product code (UPC) of the non-electronic printed publication.

Also in some examples, the electronic content may include a virtual three-dimensional object. Additionally or alternatively, the electronic content may include website content, audio, at least one image or video, and/or notes created by a first end-user different from a second end-user of the headset.

In some implementations, the indication of the electronic content may include the electronic content itself. Additionally or alternatively, the indication of the electronic content may include a link selectable to present the electronic content using the headset.

Also in some implementations, the indication regarding the electronic content may be presented responsive to identification of a user's line of sight as reaching a particular portion of the printed publication associated with the electronic content.

In another aspect, a method includes identifying, using a headset, a printed publication that includes physical pages with text. The method also includes accessing data related to electronic content that is associated with the printed publication based on the identifying, and then presenting an indication regarding the electronic content on an electronic display of the headset.

In some examples, the electronic content may be associated with the printed publication in a database of crowdsourced data, where the database may be accessed by the headset to present the indication.

In yet another aspect, at least one computer readable storage medium (CRSM) that is not a transitory signal may include instructions executable by at least one processor to identify, via input from a camera on a headset, printed material. The instructions may also be executable to access electronic content related to the printed material based on the identification and to present an indication regarding the electronic content on an electronic display of the headset.

Additionally, in some examples the instructions may be executable by the at least one processor to present the indication at least in part by highlighting a particular word of text in the printed material.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example augmented reality (AR) headset consistent with present principles;

FIGS. 4 and 5 show portions of printed material as viewed from the perspective of a user while wearing an AR headset consistent with present principles;

FIG. 6 shows a graphical user interface (GUI) that may be used to associate electronic content with certain portions of printed material consistent with present principles;

FIG. 7 shows a flow chart of an example algorithm consistent with present principles; and

FIG. 8 shows an GUI for configuring one or more settings of a device consistent with present principles.

### DETAILED DESCRIPTION

Among other things, the present application discloses techniques to present electronic content associated with keywords in printed material. A user's headset may use augmented reality (AR) scanning to scan the printed material's title or cover page as well as its author, illustrations, etc. as the view marker. If for some reason the AR headset cannot identify the printed material based on that, if available the printed material's UPC code or other barcode may be scanned and used to identify the printed material by its unique reference identifier. That in turn may inform the AR headset of which novel, edition, year, etc. of the printed material the user is reading. For example, some novels may have the same content on different pages and so knowing which edition the user is reading will inform the AR headset of what content is on what page.

The headset may then identify key words on specific pages of the printed material to provide an AR experience along with the user reading the printed material itself. To do so, the AR headset may pick up on page numbers for particular pages of the printed material.

As an example, the AR headset may detect key words that are then highlighted in the AR platform to open as floating references. E.g., certain pre-defined words may be highlighted so users can select them and show a reference page such as an online encyclopedia page.

Another example is that teachers may map their notes to a specific book and release the notes to AR devices of their students. In this way, certain pre-defined words selected by the teacher may be highlighted to assist the students in finding key references that the teacher outlines in his or her class. E.g., a student may read a book and select a link to a text or audio note from the teacher about a specific literary term or reference the student might otherwise glance over while reading.

As yet another example, the cover or box for a compact disc, digital versatile disc (DVD), or Blu-ray disc may be scanned, and associated content may then be presented via the AR headset upon recognition of the cover/box. For example, if a DVD or Blu-ray cover for a particular movie or film being held by a user is recognized by the headset, then the associated short-length trailer for that movie or film may be automatically presented via the display and speakers of the AR headset (and/or presented at the AR headset based on user command). The foregoing might also apply when, for example, a user might be wearing an AR headset and looking at a digital DVD or digital music album cover presented on a different display (e.g., smart phone display) that is being viewed by the user through the transparent display of the AR headset.

Users may also be provided with options to interact with floating content. For example, users may save their own text or audio notes to a personal notation platform so that their notes are only presented when they read associated printed text, rather than being presented for all users that might read the text while wearing an AR headset (e.g., “save this page for later”). However, users may also provide digital text and audio notes by interacting with an AR notation platform so that the notes may in fact be made available to others. For example, an audio recording from a person may be presented via an AR device for listening by others, with the initial recording of the audio of the person being triggered by the person indicating a predefined phrase such as “take a note” as recognized by that person's AR device. The audio recording may then be associated with the particular word or sentence at which the person was identified as looking when speaking the phrase “take a note”.

Additionally, an AR device operating consistent with present principles may allow users to review their notes, collate their notes, and/or generate a notes outline via a graphical user interface presented by the AR device. For a printed book, for example, users may provide notes to the system while reading the book and then create an outline after they finish reading for a test or exam that might be administered on the book. This may apply to cloud-based content as well as content stored locally at a given end-user device.

Additionally, in some examples a user may confirm or reject a notation from someone else, e.g., if the notes are open-sourced and editable (e.g., via a graphical user interface presented via an AR device). Further still, a content management company may provide a crowd-sourcing platform allowing users to interact as discussed above to provide feedback, which may then train the system such as via machine learning to determine other electronic content (e.g., notes) to associate with other portions of printed material based on trends determined by the machine learning/artificial intelligence model. To this end, supervised or unsupervised training of one or more deep or recurrent neural networks in the AI model may occur to optimize the neural network(s) for making such inferences. For example, optimization/training may occur using one or more classification algorithms and/or regression algorithms along with inputs of user selections of electronic content to associate with certain keywords of the printed material.

Further still, another aspect of present principles in terms of note taking is that a user might be wearing an AR headset while highlighting portions of pages of a printed book using a physical, neon yellow highlighter marker. This and other behaviors may be automatically tracked using cameras on the AR headset and, for example, the headset may digitally identify and track the highlighted sentence, chapter, page, etc. so that the AR headset may later (upon user command) indicate the locations of the highlighted portions and even present the text of the highlighted portions themselves on its electronic display. Other example behaviors as referenced in the preceding sentence may include dog-earring/folding top outer corners of respective pages of the book or making a unique mark (e.g., check mark on a top outer corner of the page) for the user to easily identify that page later.

Furthermore, in some examples not just end users but companies may create their own original content for the AR platform that can be displayed along with the printed material. In this manner, companies may sell additional AR content to provide an enhanced, electronic user interface to use with pre-existing books or other printed materials. The companies may even curate the content and update the content over time as electronic content may change. Additionally, new electronic content may even be enabled for presentation only on specific or special days (e.g., weekends, Thanksgiving, the month of September, etc).

Thus, when a user is reading printed material and wearing an AR headset, electronic illustrations may automatically appear, appear based on user input, appear when certain key words are looked at, and/or appear separately on another device such as the user's smart phone.

Providing a few other examples consistent with present principles, consider an adult reading a book aloud to children. Each child may be wearing an AR headset and AR content may be displayed on each one's headset display as a throw projector or hologram, and/or may be displayed on another monitor in the room for the children to view it while the adult reads the book to them.

As another example, content companies may display their own electronic illustrations, scenes from a movie, movie clips, or other content based on the contextual information of the printed material.

As yet another example, present principles may be used for marketing. For example, the technology disclosed herein may be used to drive targeted marketing in the form of advertising. E.g., a user may read about a product or destination (or other location) in a printed publication, which could cause their AR headset produce either links or coupons for the product/destination for the user to select while reading. Thus, for example, a user might be reading about a certain dress that a character is wearing in a novel, and an advertisement for the dress from a certain retailer may pop up on his or her headset along with a special coupon for the user to purchase the dress.

Prior to delving further into the details of the instant techniques, with respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

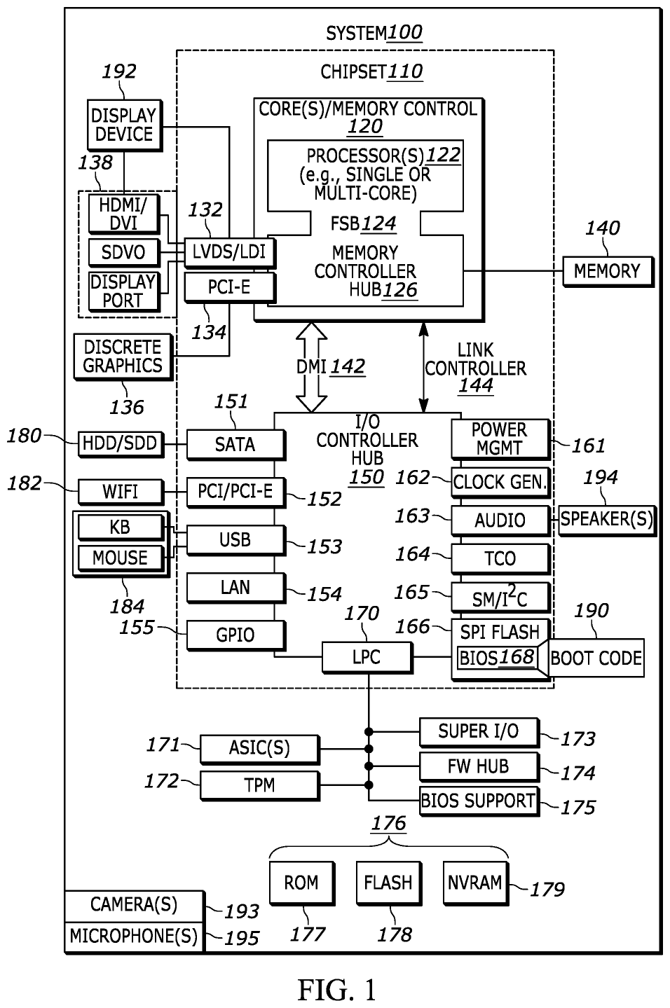

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may further include an audio receiver/microphone 195 that provides input from the microphone 195 to the processor 122 based on audio that is detected, such as via a user providing audible input to the microphone 195 consistent with present principles. Still further, the system 100 may include a camera 193 that gathers one or more images and provides input related thereto to the processor 122. The camera 193 may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

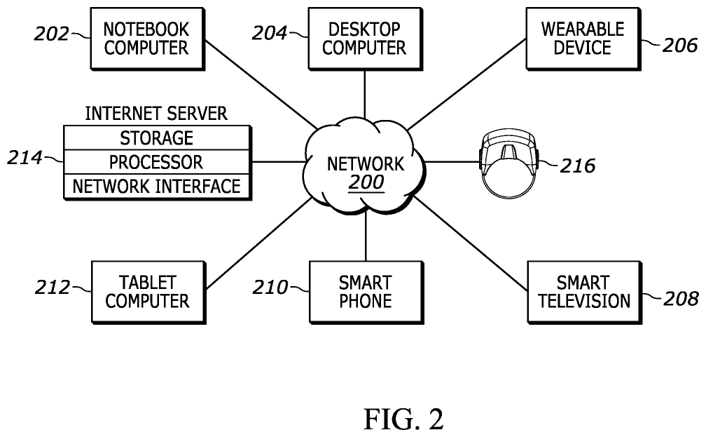

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a headset 216, and a server 214 such as an Internet server that may provide cloud storage accessible to the devices 202-212, 216. It is to be understood that the devices 202-216 are configured to communicate with each other over the network 200 to undertake present principles.

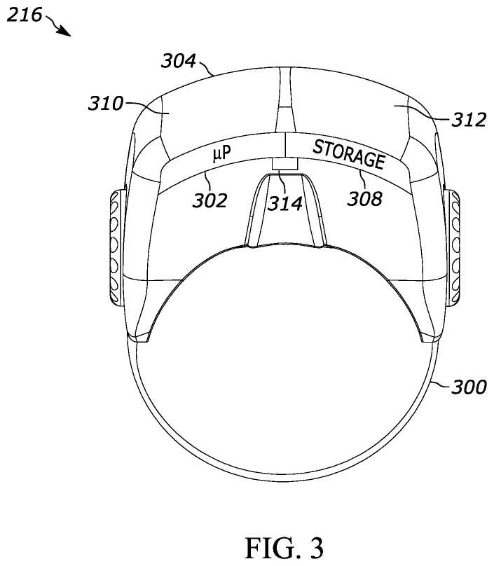

Now describing FIG. 3, it shows a perspective view of a headset, such as the headset 216, consistent with present principles. The headset 216 may include a housing 300, at least one processor 302 in the housing, and a transparent “heads up” display 304 accessible to the at least one processor and coupled to the housing. Additionally, the headset 316 may include storage 308 accessible to the processor 302 and coupled to the housing 300, as well as one or more cameras 310, 312 accessible to the processor 302 and coupled to the housing 300 for use as disclosed herein. Thus, it is to be understood that the cameras 310, 312 may be oriented to face away from the headset 216 in the direction in which a user's head would be oriented when wearing the headset 216. The headset 216 may also include one or more cameras 314 oriented inward to image the user's eyes while the person wears the headset 216 for eye tracking consistent with present principles.

Still further, note that the headset 216 may include still other components not shown for simplicity, such as a network interface for communicating over a network such as the Internet and a battery for powering components of the headset 216. Additionally, note that while the headset 216 is illustrated as computerized smart glasses, the headset 216 may also be established by another type of augmented reality (AR) headset, or even a virtual reality (VR) headset in some examples that may not have a transparent display but is still be able to present electronic content such as virtual AR objects along with a real-world, real-time camera feed of an environment imaged by one or more of the cameras 310, 312 to provide an AR experience to the user. Also note that electronic contact lenses with their own respective heads up displays may also be used consistent with present principles.

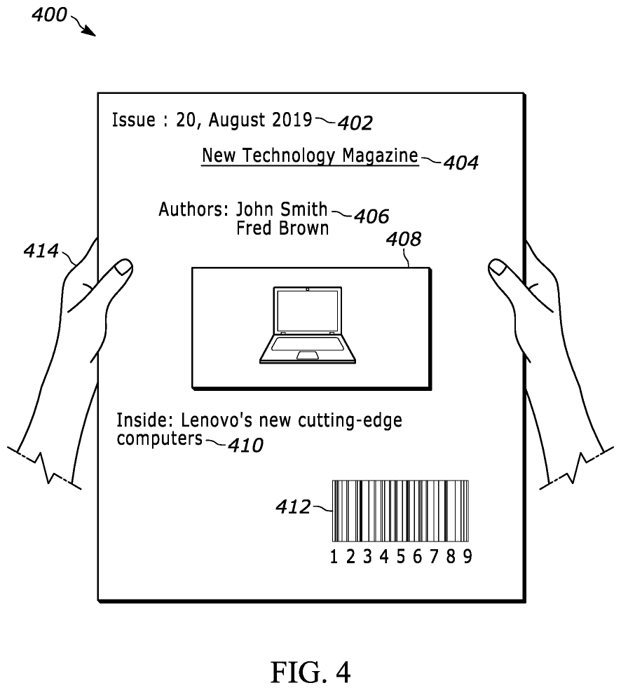

Now in reference to FIG. 4, it shows an example cover page 400 of a magazine as viewed by a user 414 through a transparent display of an AR headset such as the headset 216 described above. Consistent with present principles, the user's AR headset may, using input from one or more of its cameras and object/text recognition, lookup and identify the magazine and even the particular issue indicated by the cover page 400 by accessing data on a server correlating magazine identity to various aspects of the magazine that might be identified. For example, the text 402 indicating “Issue: 20, August 2019” may be identified to subsequently identify both the magazine itself and electronic content associated with that issue of the magazine.

Additionally or alternatively, the AR headset may also identify the magazine and/or particular issue via the magazine's title 404, author(s) 406, images 408, cover page text 410, and even the magazine's universal product code (UPC) 412. Quick response codes that might be disposed on the magazine may also be used.

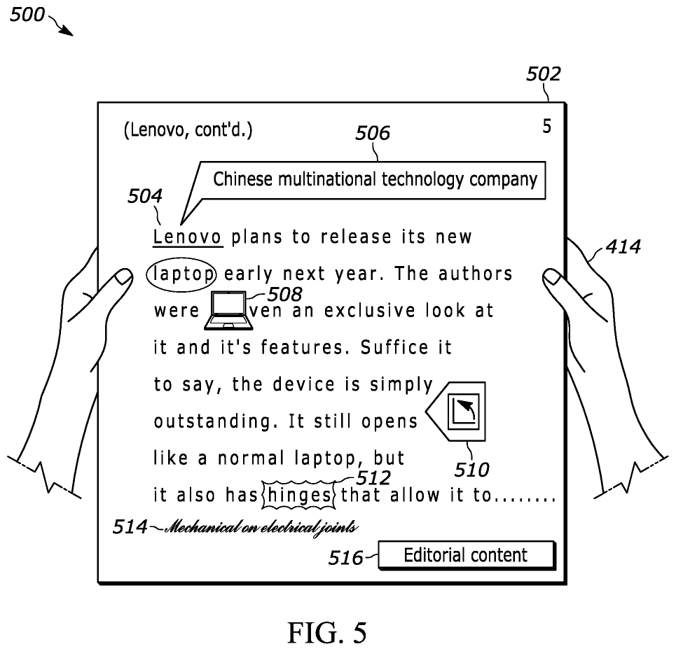

Before moving on to the description of FIG. 5, also note that while a magazine is being used as an example of a non-electronic printed publication that has physical pages with text and that can be held physically by the user 414 via his or her hands as shown, present principles apply to other printed publication types and other materials as well, such as books, newspapers, or even class handouts provided by an instructor or teacher.

Now describing FIG. 5, it shows an example inside page 500 of the same magazine as referenced above. A page number 502 is shown (page five, in this example). Based on this page number or any of the other non-electronic content recognized from the page 500, the user's AR headset may identify electronic content associated with various words (or even images) shown on the page 500. The content may be recognized by, e.g., using optical character recognition, object recognition, image recognition, etc.

As an example, the first word of the page (“Lenovo”) has been highlighted via a link 504 represented on the AR headset as integrated with the printed text for the word and appearing at the real-world current location of the printed text. The link 504 may indicate associated electronic content and be selectable by the user 414 to command the AR headset to present the electronic content itself. For example, selection of the link 504 may command the AR headset to access an Internet webpage from an online, crowdsourced encyclopedia website that is associated with the word and then present the webpage on the AR headset's transparent display, either over top of the user's view of the page 500 or off to the side such that it does not obstruct the user's view of the page 500. E.g., the webpage may be presented within the user's field of view but to the right of the page 500 so that it might obstruct the view of one of the hands of the user 414 that are shown in FIG. 5. As also shown in FIG. 5, the link 504 may be accompanied by a preview window 506 indicating a first line of text from the associated webpage itself.

Note that the link 504 itself may be selectable based on execution of eye tracking to identify the user 414 as staring at the link for a threshold non-zero period of time, such as three seconds. As another example, the link 504 may be selectable based on voice command.

Then as the user 414 progresses in reading the text on the page 500, the AR headset may track the user's line of sight using an eye tracking algorithm and input from a camera on the headset that is imaging the user's eyes. Then when the user 414 is identified as beginning to read the word “laptop” on the second line of the page 500, the word may be highlighted using the AR headset by presentation on its display of a circle shown in FIG. 5 as circling the word. A three-dimensional (3D) virtual object 508 may also be shown on the AR headset's display that has been associated with the word “laptop”. In this example, the 3D object 508 is a 3D image of a laptop computer. Also note again that while the image 508 is shown as overlaid on the user's view of the page 500, in other examples the image 508 may be presented off to the side of the page 500 for viewing, as may any of the other visual electronic content types disclosed herein.

Then as the user 414 continues to read the page 500 and his/her line of sight arrives at the word “opens”, a video 510 may either be automatically presented on the AR headset's display or presented responsive to selection of the word “opens” if represented as a link using the AR headset's display. In this example, the video 510 demonstrates movement of a laptop to open it. Also note that in other examples, an audio recording of a person speaking about laptops or an image from the Internet of a laptop may be presented instead of the video 510.

As the user 414 continues to read even farther down the page 500 and his or her line of sight arrives at the word “hinges”, highlighting 512 of the word may be presented and indicate associated electronic content that is available for viewing. Additionally, an electronic representation 514 of cursive notes provided electronically by another user may be presented, either automatically upon the user's line of sight reaching the word “hinges” or upon the user 414 selecting the word if represented as a link using the AR headset's display.

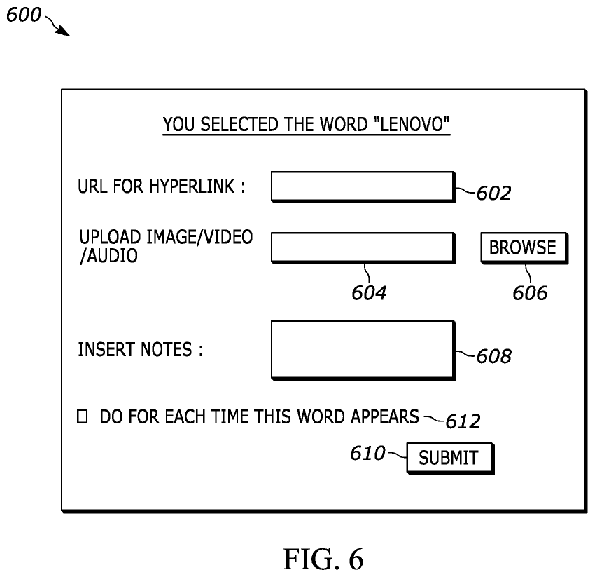

As also shown in FIG. 5, in some examples a selector 516 may be superimposed on the page 500 via the AR headset's display for selection by the user 414 for the user himself or herself to associate electronic content with one or more words shown on the page 500. Thus, selection of the selector 516 may cause the headset to prompt the user to look at a word presented on the page for a threshold non-zero amount of time or to provide voice input indicating the word, which in turn may cause the graphical user interface (GUI) 600 of FIG. 6 to be presented either on the AR headset's display or even on the display of a cell phone, laptop, or tablet of the user in communication with the AR headset. The GUI 600 may then be used as a way for an end-user to specify electronic content to associate with the selected word to crowdsource electronic content from end-users for association with the magazine rather than having the electronic content be specified by the magazine's publisher, the manufacturer of the AR headset, a content provider, or another corporate entity. Notwithstanding, note that in other examples the GUI 600 may be used by such entities as well.

In any case, as shown in FIG. 6 the GUI 600 may include an indication 602 of the word that was selected. In this case, the word is “Lenovo”. The user may then enter a web address and/or Uniform Resource Locator (URL) into input box 602 to associate with the word. Additionally or alternatively, the user may upload or provide a link to a particular image, video, or audio recording to associate with the word via input box 604. If the image, video, or audio recording is stored locally or in cloud storage, a browse selector 606 may even be selected for the user to browse storage to find the image, video, or audio sample as stored locally or in cloud storage.

Additionally, in some examples the GUI 600 may include an input box 608. The box 608 may be selected and then the user may either use a stylus to handwrite notes into the box 608, speak words that may be recognized via voice recognition for insertion into the box 608, and/or type words into the box 608 using a keyboard. The notes provided to box 608 may then be associated with the word “Lenovo” based on selection of the submit selector 610, as may any of the other electronic content indicated via the boxes 602, 604.

However, note that before the user selects the selector 610, the user may choose to select the check box shown for option 612 to associate the electronic content(s) the user has indicated not just with the particular word as selected from a given page of the magazine but to associate the indicated electronic content with the word wherever it appears in the magazine.

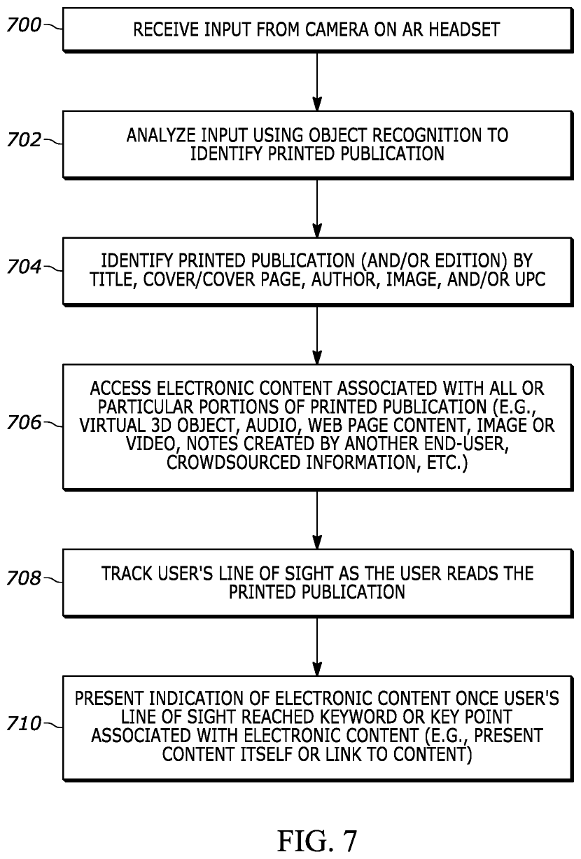

Continuing the detailed description in reference to FIG. 7, it shows example logic consistent with present principles that may be executed by a device such as the system 100, an AR headset as disclosed herein, and/or a server in communication with the AR headset. Also note that the logic of FIG. 7 as well as the other functions described herein in reference to an AR headset may in some embodiments be executed by other device types, such as a smart phone or other mobile device with ability to present augmented reality content on its display.

Beginning at block 700, the device may receive input from one or more cameras on the AR headset. The logic may then move to block 702 where the device may analyze the input using object recognition to, at block 704, identify a printed publication or other printed material being held by a user consistent with present principles. Image recognition and/or optical character recognition may also be used, as may other recognition engines for identifying the printed publication. In any case, as set forth above the printed publication may be identified and even the particular edition, issue, volume, etc. As also set forth above, the printed publication may be identified by its title, an image of its cover page or cover (e.g., book cover), its author(s), images shown on the cover or other portions of the printed publication, and even UPC code. The printed publication may also be identified from other information, such as publisher information or copyright text that might be presented on an inside page of the printed publication. A segment of the text of the corpus of the printed publication may even be used to identify it.

After block 704 the logic may then proceed to block 706 where the device may access electronic content associated with all of the printed publication and/or certain portions or words. The electronic content may be accessed via a publicly available website, database, cloud storage area, etc. which may associate the publication or particular portions thereof with various pieces of electronic content and even store the associated electronic content itself. Again note that the electronic content may include a virtual 3D object, audio content (e.g., a teacher speaking to students), a web page, an image or video, and notes created by other end-users or other crowdsourced information.

From block 706 the logic may then proceed to block 708. At block 708 the device may track the user's line of sight using eye tracking as the user reads a page of the printed publication associated with the electronic content that is accessed at block 706. From block 708 the logic may then proceed to block 710 where the device may present one or more indications on the AR headset's display of the electronic content when the user looks at the word or phrase in the printed publication that has been associated with it.

However, note that in other embodiments the device may not wait until the user's line of sight reaches the associated word or phrase. Instead, the device may highlight respective words or phrases by presenting the respective indications for the various words or phrases responsive to the user turning to or starting to read the beginning of the associated page of the printed publication.

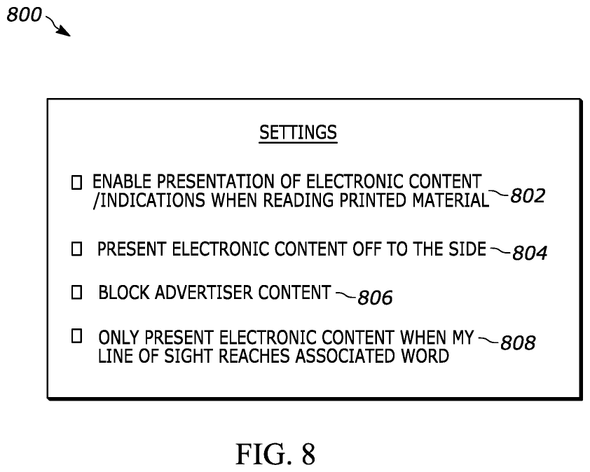

Now in reference FIG. 8, it shows an example GUI 800 that may be presented on the display of an AR headset or other device of an end-user, such as the user's smart phone. The GUI 800 may be used to configure one or more settings of the AR headset or other device used to undertake present principles, and accordingly may include one or more options that are selectable by selecting the respective adjacent check box for each option.

As shown in FIG. 8, the GUI 800 may include a first option 802 that may be selected to configure the AR headset to enable presentation of indications of electronic content and/or presentation of the electronic content itself when the user reads printed material. For instance, selection of the option 802 may configure the AR headset to undertake the functions described above in reference to FIGS. 4-6 as well as to undertake the logic of FIG. 7.

The GUI 800 may also include an option 804 that may be selectable to configure the AR headset to present electronic content associated with printed material to the side of the user's view of the printed material so as to not obstruct the user's view of the printed material with electronic content. The GUI 800 may further include an option 806 that may be selectable to block electronic content provided by an advertiser, with the understanding that in some examples advertisements and even coupons for certain products may establish electronic content accessed by and presented at the AR headset but that a user might not wish to see such content. Additionally, the GUI 800 may include an option 808 that may be selected to configure the AR headset to only present indications of electronic content and/or the electronic content itself when the user's line of sight reaches an associated word or phrase rather than, e.g., when the user initially turns to a page having the associated word or phrase.

It may now be appreciated that present principles provide for an improved computer-based user interface that improves the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A headset, comprising:
at least one processor;
at least one display accessible to the at least one processor; and
storage accessible to the at least one processor and comprising instructions executable by the at least one processor to:
identify a non-electronic printed publication held by a user, the non-electronic printed publication comprising pages with text;
access, based on the identification, electronic content related to the non-electronic printed publication; and
present, responsive to a page turn of the printed publication, an indication regarding the electronic content on the at least one display.

2. The headset of claim 1, wherein the non-electronic printed publication is a newspaper.

3. The headset of claim 1, comprising a camera accessible to the at least one processor, wherein the non-electronic printed publication is identified based on input from the camera.

4. The headset of claim 3, wherein the non-electronic printed publication is identified based on input from the camera by copyright information for the non-electronic printed publication.

5. The headset of claim 3, wherein the non-electronic printed publication is identified based on input from the camera by publisher of the non-electronic printed publication.

6-7. (canceled)

8. The headset of claim 3, wherein the non-electronic printed publication is identified based on input from the camera by a quick response code of the non-electronic printed publication.

9. The headset of claim 1, wherein electronic content comprises a coupon.

10. The headset of claim 1, wherein the electronic content comprises an advertisement.

11. The headset of claim 1, wherein the non-electronic printed publication comprises a box for a movie, and wherein the electronic content comprises a movie trailer.

12. The headset of claim 1, wherein the electronic content comprises notes created by a first end-user that is currently using the headset.

13. The headset of claim 1, wherein the indication of the electronic content comprises the electronic content itself.

14-15. (canceled)

16. A method, comprising:
identifying, using a headset, a printed publication, the printed publication comprising physical pages with text;
accessing, based on the identifying, data related to electronic content that is associated with the printed publication; and
presenting, on an electronic display of the headset and responsive to a page turn of the printed publication, an indication regarding the electronic content.

17. The method of claim 16, wherein the electronic content is associated with the printed publication in a database of crowdsourced data, the database being accessed by the headset to present the indication.

18. (canceled)

19. At least one computer readable storage medium (CRSM) that is not a transitory signal, the computer readable storage medium comprising instructions executable by at least one processor to:
identify, via input from a camera on a headset, printed material;
access, based on the identification, electronic content related to the printed material; and
present, responsive to a page turn of the printed material, an indication regarding the electronic content on an electronic display of the headset.

20. The CRSM of claim 19, wherein the instructions are executable by the at least one processor to:
present the indication at least in part by circling a particular word of text in the printed material.

21. The headset of claim 1, wherein the instructions are executable to:
present a graphical user interface (GUI) on the at least one display, the GUI being different from the indication and different from the electronic content, the GUI being usable to configure one or more settings of the headset, the GUI comprising a first option that is selectable to configure the headset to subsequently: identify respective non-electronic printed publications, access electronic contents respectively associated with the respective non-electronic printed publications, and present respective indications regarding the respective electronic contents.

22. The headset of claim 21, wherein the GUI comprises a second option different from the first option, and wherein the second option is selectable to configure the headset to present the respective electronic contents to the side of the user's view of pages of the respective non-electronic printed publications.

23. The headset of claim 21, wherein the GUI comprises a second option different from the first option, and wherein the second option is selectable to configure the headset to block advertisements forming the respective electronic contents.

24. The method of claim 16, wherein the printed publication is identified using input from a camera on the headset and execution of optical character recognition.

25. The CRSM of claim 19, wherein the indication is presented to the side of a user's view of the pages of the printed material.
